(19) United States
(12) Patent Application Publication
(10) Pub. No.: US 2016/0307046 A1
(43) Pub. Date: Oct. 20, 2016

(54) Content Output Apparatus, Content Output System, Content Output Method, And Computer Readable Storage Medium

(71) Applicant: CASIO COMPUTER CO., LTD., Shibuya-ku (JP)

(72) Inventor: Kunihiro MATSUBARA, Tokyo (JP)

(21) Appl. No.: 15/073,161

(22) Filed: Mar. 17, 2016

(30) Foreign Application Priority Data
Apr. 14, 2015 (JP) 2015-082790

(51) Int. Cl. G06K 9/00; H04N 7/18; H04N 9/31

(52) U.S. Cl. CPC G06K 9/00771; H04N 9/3141; H04N 7/183

(57) ABSTRACT

A content output apparatus is provided with an output unit which starts outputting content based on entry of a person into a predetermined area, a detection unit which detects a person viewing the content outputted by the output unit, and an evaluation unit which evaluates the content based on a ratio of a content output time outputted by the output unit and a detect time representing a person detected by the detection unit.

### CROSS-REFERENCE TO RELATED APPLICATIONS

This application is based upon and claims the benefit of priority from prior Japanese Patent Application No. 2015-082790, filed Apr. 14, 2015, the entire contents of which are incorporated herein by reference.

### BACKGROUND OF THE INVENTION

1. Field of the Invention

The present invention relates to a content output apparatus, a content output system, a content output method, and a computer readable storage medium.

2. Description of the Related Art

In the prior art, in order to enhance impression on a browser, there is proposed a video output apparatus which projects video content on a screen formed into the shape of an outline of the content (for example, Jpn. Pat. Appln. KOKAI Publication No. 2011-150221).

In this type of apparatus including the technique described in the above patent document, content is only unilaterally outputted and output in accordance with a previously set content, and materials for judging effects as an advertising apparatus, such as the actual number of browsers who have browsed the outputted content, cannot be obtained.

This invention provides a content output apparatus, which can obtain information as a judgement material for ambient reaction to output of content, a content output system, a content output method, and a computer readable storage medium.

### BRIEF SUMMARY OF THE INVENTION

One aspect of the present invention comprises a output unit which outputs content based on entry of a person into a predetermined area, a detection unit which detects a person viewing the content outputted by the output unit, and an evaluation unit which evaluates the content based on a ratio of a content output time according to the output unit and a time representing a person detected by the detection unit.

The present invention can obtain information as a judgement material for ambient reaction to output of content.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a connection configuration of the entire signage system according to an embodiment of the present invention;

FIG. 2 is a perspective view showing an appearance configuration of a signage device according to the same embodiment;

FIG. 3 is a block diagram showing a functional configuration of an electronic circuit of the signage device according to the same embodiment;

FIG. 4 is a view exemplifying a data name and a output time of content data stored in a content memory according to the same embodiment;

FIG. 5 is a view exemplifying a output order of the content data according to the same embodiment.

FIG. 6 is a flowchart showing processing content related to content output in the signage device according to the same embodiment;

FIG. 7 is a flowchart showing subroutine content of a content output control step in FIG. 6 according to the same embodiment;

FIG. 8 is a timing chart showing a relationship between a human detection sensor and content output operation according to the same embodiment;

FIG. 9 is a timing chart showing a relationship between a human detection sensor and content output operation according to the same embodiment; and

FIG. 10 is a view showing an example of a content output log stored in a log storage part according to the same embodiment.

### DETAILED DESCRIPTION OF THE PREFERRED EMBODIMENTS

Hereinafter, an embodiment in which the present invention is applied to a signage system used in a store will be described with reference to the drawings.

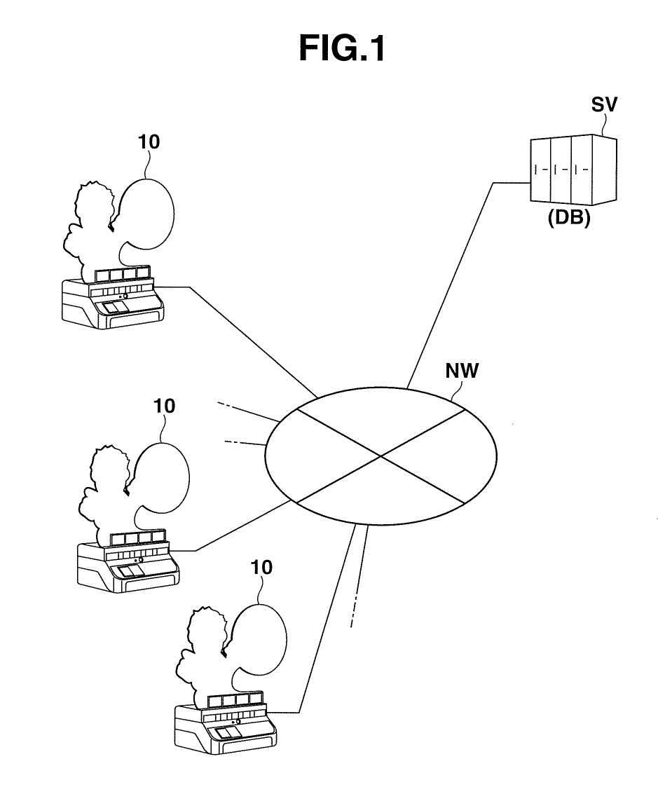

FIG. 1 is a view showing a connection configuration of the entire signage system. A plurality of signage devices 10 installed in a counter in a store are connected to a content distribution server SV through a network NW including a wireless LAN.

The content distribution server SV is provided with a database (DB) storing a plurality of content data to be outputted by each of the signage devices 10.

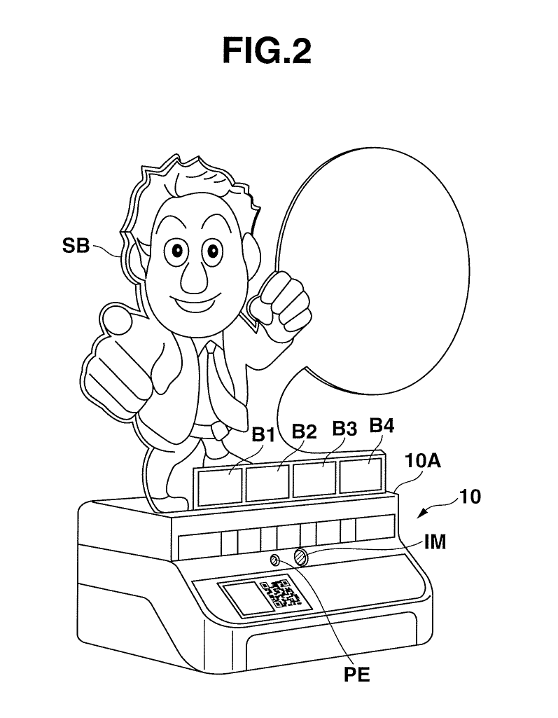

FIG. 2 is a perspective view showing an appearance configuration of a signage device 10. The signage device 10 is an electronic mannequin using a projector technology, and an exchangeable signage board SB is provided upright on a front end side of an upper surface of a device housing 10A. The signage board SB is installed so as to be contained in an originally rectangular projectable region of the signage device 10 and has a semi-transmissive plate-shaped configuration having any shape.

In the signage board SB, an optical image emitted through a rear-projection type of projection lens (not shown) provided on the upper surface of the device housing 10A is projected from the back side of the signage board SB, whereby an image as illustrated, for example, is displayed on the signage board SB.

A plurality of buttons, here four operation buttons B1 to B4, are projected together at a lower portion of the signage board SB. When a viewer performs a touch operation on any of the buttons, the operation position is detectable by an array of linear infrared ray sensors arranged at a board mounting base portion and each having directivity.

The device housing 10A is provided on its front surface with an imaging portion IM of a wide-angle optical system for photographing an environment on the front side of the signage device 10 and a human detection sensor PE for detecting a person in a predetermined area on the front side of the signage device 10.

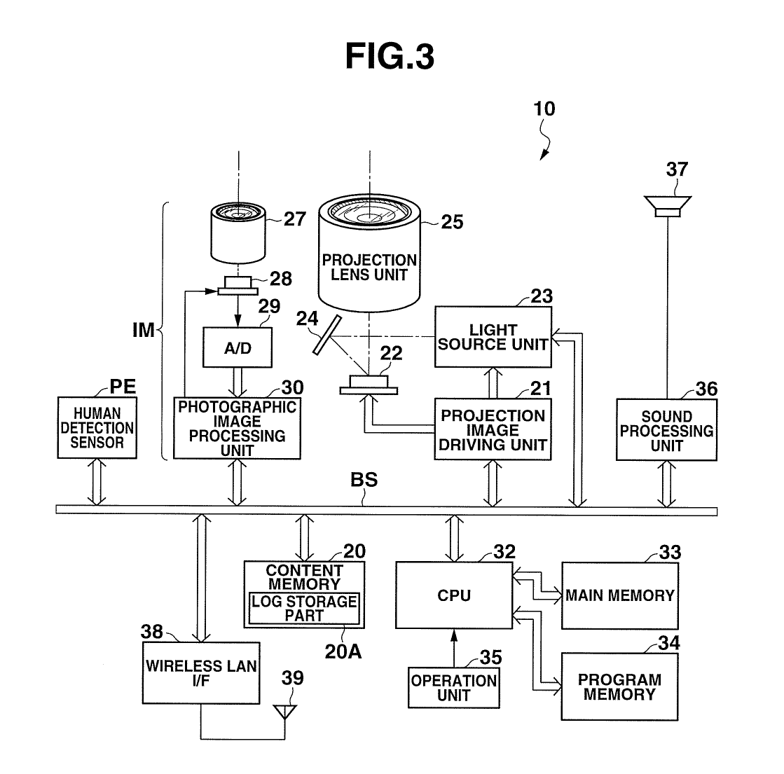

Next, a functional configuration of an electronic circuit will be described as the main part of the signage device 10 with reference to FIG. 3. A content memory 20 stores a plurality of content data received from the content distribution server SV and, at the same time, stores log data in a log storage part 20A as described below.

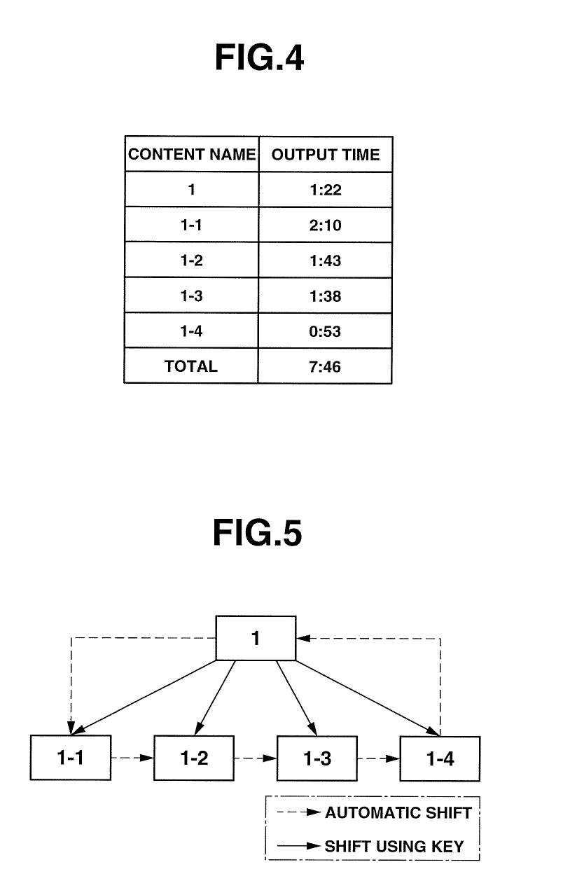

FIG. 4 shows an example of the plurality of content data stored in the content memory 20 and output times of the content data. In this embodiment, the output times of the five content data whose content names are “1”, “1-1”, “1-2”, “1-3”, and “1-4” are as illustrated.

The content data whose content name is “1” is content data positioned at the head of a series of content data and comprehensively introducing a commodity or the like.

Meanwhile, the content data whose content names are “1-1”, “1-2”, “1-3”, and “1-4” are each content data introducing a specific commodity in detail.

FIG. 5 is a view exemplifying a output order of the content data stored in the content memory 20. As illustrated by the dashed arrows in FIG. 5, particularly in such a state that each of the operation buttons B1 to B4 is not performed, the content data whose content names are “1”, “1-1”, “1-2”, “1-3”, and “1-4” are circularly outputted so as to be outputted in a loop manner.

Meanwhile, as illustrated by the solid arrows in FIG. 5, if the operation buttons B1 to B4 are operated during output of the content data whose content name is “1”, the output of the content data whose content name is “1” is directly shifted to output of the content data whose content names are “1-1”, “1-2”, “1-3”, and “1-4” in response to the button operation.

The content data stored in the content memory 20 are all constituted of moving image data and sound data. The moving image data in the content data is read out by a CPU 32 to be described below and transmitted to a projection image driving unit 21 through a system bus BS.

The projection image driving unit 21 display-drives a micromirror element 22, which is a display element, by higher time-division drive obtained by multiplication of a frame rate following a predetermined format, for example, 120 [frames/second], division number of a color component, and the number of display gradations.

The micromirror element 22 displays and operates, by an individual high-speed ON/OFF operation, each inclination angle of a plurality of micromirrors corresponding to, for example, WXGA (lateral 1280 pixels×longitudinal 768 pixels) arranged in an array shape, thereby forming the optical image by reflection light.

The light source unit 23 cyclically emits R, G, B primary color lights in time division. The light source unit 23 has an LED as a semiconductor light emitting device and repeatedly emits R, G, B primary color lights in time division.

The LED of the light source unit 23 may include an LD (semiconductor laser) and an organic EL element as the LED in a broad sense. The primary color lights from the light source unit 23 are reflected by a mirror 24 and applied to the micromirror element 22.

Then, the reflected light from the micromirror element 22 forms an optical image. The formed optical image passes through a projection lens unit 25 and is projected onto the back side of the signage board SB.

The imaging portion IM includes a photographic lens portion 27, facing the front direction of the signage device 10, and a CMOS image sensor 28 which is a solid-state imaging device arranged at a focus position of the photographic lens portion 27.

An image signal obtained by the CMOS image sensor 28 is digitized by an A/D converter 29 and then sent to a photographic image processing unit 30.

The photographic image processing unit 30 scans and drives the CMOS image sensor 28 for execution of a photographing operation to convert image data obtained by photographing into a data file, and, thus, to transmit the data file to the CPU 32 to be described below.

The photographic image processing unit 30 recognizes and extracts a human portion from the image data obtained by photographing through contour extraction processing and face recognition processing and then determines a sex and an age group as attribute information from an arrangement configuration such as eyes and a nose as constituents of the face portion. The results of the determination processing including the face recognition are sent to the following CPU 32.

Moreover, a detection signal in a pyroelectric sensor constituting the human detection sensor PE is sent to the CPU 32.

A CPU 32 controls all operations of each of the above circuits. The CPU 32 is connected directly to a main memory 33 and a program memory 34. The main memory 33 is constituted of an SRAM, for example, and functions as a work memory of the CPU 32. The program memory 34 is constituted of an electrically rewritable nonvolatile memory, such as a flash ROM, and stores therein an operation program to be executed by the CPU 32, various standardized data items, and the like.

The CPU 32 reads the operation program, standardized data, and the like stored in the program memory 34, develops and stores the read program, data, and the like in the main memory 33, and executes the program to thereby perform overall control on the signage device 10.

The CPU 32 carries out various projection operations according to an operation signal from an operation unit 35. The operation unit 35 receives a detection signal from the aforementioned infrared ray sensor array provided in a main body of the signage device 10 and sends a signal according to received operation to the CPU 32.

The detection signal is a key operation signal of some operation keys including a power key or a signal from the aforementioned infrared ray sensor array detecting operation to the operation buttons B1 to B4 virtually projected onto a portion of the signage board SB.

The CPU 32 is further connected to a sound processing unit 36 and a wireless LAN interface (I/F) 38 through the system bus BS. In the aforementioned operation of the CPU 32, each operation may be performed by providing a single CPU or providing individual CPUs.

The sound processing unit 36 is provided with a sound source circuit of a PCM sound source or the like and converts sound data in content data, read from the content memory 20 during the projection operation, into analog data and drives a speaker unit 37 to release sound or generate a beep sound or the like if necessary.

The wireless LAN interface 38 is connected to the nearest wireless LAN router (not shown) through a wireless LAN antenna 39 to transmit and receive data and communicates with the content distribution server SV of FIG. 1.

Next, the operation of the above embodiment will be described.

In the signage device 10, the operation program, the standardized data, and the like read from the program memory 34 by the CPU 32 and to be executed after being expanded in the main memory 33 are stored beforehand in the program memory 34 at the time of shipment of the signage device 10 from a factory as a product. In addition, content appropriately updated and recorded by processing such as version upgrade through the network NW are included when the signage device 10 is installed in a store or the like.

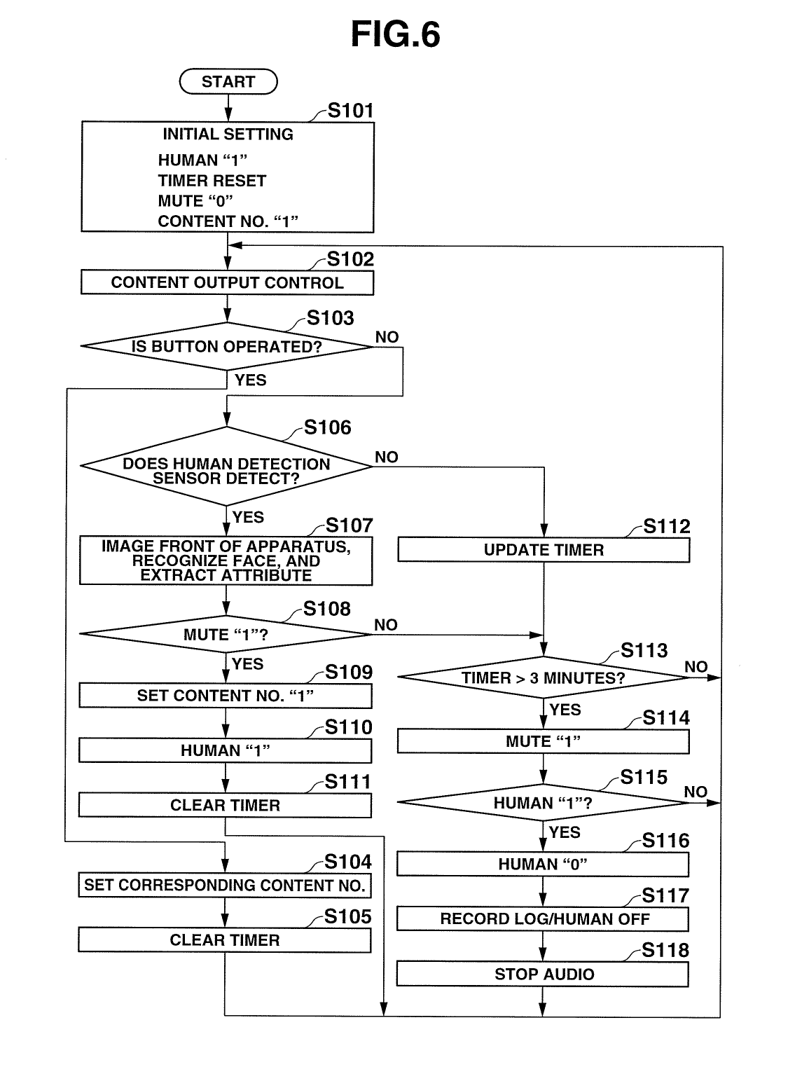

FIG. 6 is a flowchart showing processing content related to a output of content data executed by each of the signage devices 10 installed in a store.

At the beginning of the processing, the CPU 32 sets a “human” flag to “1”, resets a counting value of a timer, sets a “mute” flag to “0”, and sets a content number (No.) to “1” (Step S101). Those initial settings are held by the main memory 33.

The “human” flag is a flag set to “1” when there is a detection output of the human detection sensor PE and it is judged that a customer who has come to a store (hereinafter referred to simply as “a customer”) exists in front of the signage device 10, and set to “0” when it is judged that a customer does not exist, and a default value “1” is set at the beginning of the processing in the device, as described above.

The timer counts a state in which there is no detection output from the human detection sensor PE and a customer does not exist in front of the signage device 10.

The “mute” flag is a flag set to “1” when a customer does not exist in front of the signage device 10, so that an output of audio content is stopped, and set to “0” when the audio content is outputted together with content data of a moving image, and a default value “1” is set at the beginning of the processing in the device, as described above.

The content number is set to “0” after selection of content and during output of the content. Meanwhile, as shown in FIGS. 4 and 5, in such a state that the content is shifted by selecting any of the content names “1”, “1-1”, “1-2”, “1-3”, and “1-4”, the content name is held as it is as the content number. At the beginning of this processing, “1” as the content data which comprehensively introduces a commodity or the like is set as a default value which is a starting content.

After termination of the initial setting, the CPU 32 executes a output control of content in accordance with a setting state at that point (Step S102).

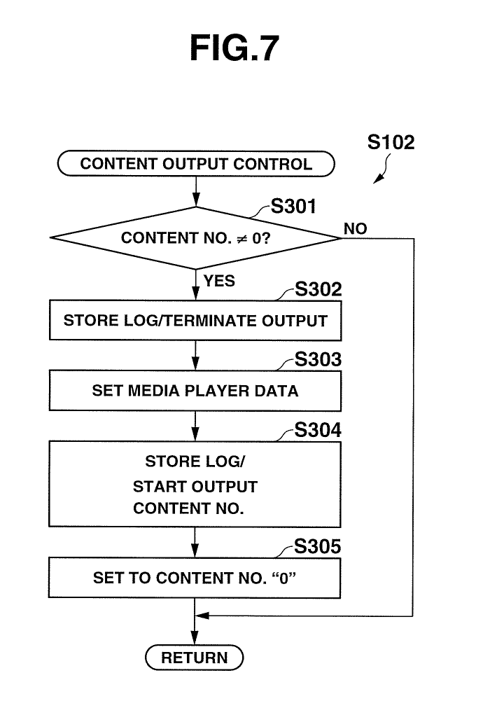

FIG. 7 is a flowchart showing processing content of a subroutine of a content output control performed by the CPU 32, and at the beginning of the processing, whether a output state of content data is newly set is judged by whether the content number is not “0” (Step S301).

Here, the content number is “0”, and when it is judged that the content data is being outputted (No in Step S301), the subroutine in FIG. 7 is thus terminated to return the processing to the main routine in FIG. 6, and, thus, to continue output of the content data at that time.

In Step S301, the content number is not “0”, and if it is judged that output of content data is required to be newly set (Yes in Step S301), the CPU 32 searches the log storage part 20A and performs update and storing related to termination of output of content data in which output is set last (Step S302).

After that, the CPU 32 sets data necessary for a program for content output, “media player”, and starts content output to read content data having a newly selected content name from the content memory 20, and, thus, to output the content data (Step S303).

Moreover, the CPU 32 additionally records the content name of the content data whose output has been started and status information whose output has been started in the log storage part 20A while relating the content name and the status information to time information obtained from an internal clock (step S304). After that, the CPU 32 newly sets “0” to the content number while judging that output of content data is not required to be newly set (Step S305), thus terminates the subroutine in FIG. 7, and returns to the main routine in FIG. 6.

In the main routine in FIG. 6, after processing of the content output control, the CPU 32 judges whether or not any of the operation buttons B1 to B4 has been operated by the operation unit 35 (Step S103).

When it is judged that any of the operation buttons B1 to B4 has been operated (Yes in Step S103), any of the corresponding content whose content names are “1-1”, “1-2”, “1-3”, and “1-4” has been directly selected by a customer. At this time, the CPU 32 sets the selected content data to the content number (Step S104).

Thereafter, after the counting value of the timer is cleared (Step S105), the subroutine of the content output control in Step S102 is executed.

In this subroutine, the CPU 32 first judges that the content number is not “0” (Yes in Step S301) and performs update and storing related to termination of output of content data which has been outputted by up to the time (Step S302).

Subsequently, the CPU 32 sets data necessary for a program for content output, “media player”, and starts content output to output the content data having the content name corresponding to the button operation performed by a customer (Step S303).

Moreover, the CPU 32 additionally records the content name of the content data whose output has been started and the status information whose output has been started in the log storage part 20A while relating the content name and the status information to time information obtained from an internal clock (step S304). After that, the CPU 32 sets “0” to the content number to show that the selected content data is being outputted (Step S305), thus terminates the subroutine, and returns to the main routine in FIG. 6.

In Step S103, when it is judged that none of the operation buttons B1 to B4 is operated (No in Step S103), the CPU 32 then judges whether or not a customer exists in front of the signage device 10 based on the detection output of the human detection sensor PE (Step S106).

Here, if it is judged that a customer exists in front of the signage device 10 from the detection output of the human detection sensor PE (Yes in Step S106), an image in front of the signage device 10 is photographed by the imaging portion IM, and the contour extraction processing and the face recognition processing are applied to the obtained image by the photographic image processing unit 30. In this manner, after the front of the signage device 10 and the nearest human portion are recognized and extracted, a sex and an age group as attribute information are obtained from an arrangement configuration such as eyes and a nose as constituents of the face portion (Step S107). The attribute information is stored together in the log storage part 20A of the content memory 20 by the CPU 32 in log storage processing in Step S304 during processing of the content output control in Step S102 to be executed immediately thereafter.

After that, the CPU 32 judges whether or not the “mute” flag is “1” at that point, that is, whether or not a customer does not exist in front of the signage device 10 for a predetermined time or more until just before up to now and the output of the audio content is stopped (step S108).

Here, the “mute” flag is “1”, and if a customer does not exist in front of the signage device 10 for a predetermined time or more until just before (Yes in Step S108), “1” is set to the content number in order to start output from the starting content data whose content name is “1” to a customer newly entered a predetermined area on the front side of the signage device 10 (Step S109).

In addition, the CPU 32 sets the “human” flag to “1” (Step S110), clears the counting value of the timer (Step S111), and then returns to the processing from Step S102 in order to output the content data again.

Meanwhile, in Step S106, if it is judged that there is no detection output from the human detection sensor PE and a customer does not exist in front of the signage device 10 (No in Step S106), after the counting value of the timer inside the CPU 32 is updated (Step S112), whether or not a state in which no person exists in front of the signage device 10 has been maintained for a predetermined time is judged by whether or not the updated counting value of the timer is more than a predetermined time; for example, 3 minutes (Step S113).

Here, the counting value of the timer is still not more than 3 minutes, and when it is judged that the state in which no person exists in front of the signage device 10 is not maintained for a predetermined time (No in Step S113), the CPU 32 returns to the processing from Step S102 in order to maintain this state.

Meanwhile, in Step S113, the updated counting value of the timer is more than a predetermined time, for example, 3 minutes, and if it is judged that the state in which no person exists in front of the signage device 10 has been maintained for a predetermined time (Yes in Step S113), the CPU 32 sets “1” to the “mute” flag (Step S114) and thereafter judges whether or not the “human” flag is “1” (Step S115).

Here, when it is judged that the “human” flag is not “1” but “0” (No in Step S115), the processing is returned to Step S102 while judging that an audio content stop state is already set.

Meanwhile, in Step S115, when it is judged that the “human” flag is “1” (Yes in Step S115), “0” is set to the “human” flag in order to set the audio content stop state again (Step S116).

The CPU 32 allows the log storage part 20A of the content memory 20 to store the absence of a customer from the signage device 10 (Step S117). After that, the CPU 32 stops output of audio content from the sound processing unit 36 in accordance with the “mute” flag (Step S118) and returns to the processing from Step S102.

Meanwhile, in Step S108, the “mute” flag is not “1” but “0”, and if it is judged that a customer exists in front of the signage device 10 from the detection output from the human detection sensor PE in such a state that the audio content output is not stopped (No in Step S108), the CPU 32 proceeds to the processing from Step S113 and judges whether or not the state in which no person exists in front of the signage device 10 has been maintained for a predetermined time depending on whether or not the counting value of the timer is more than a predetermined time; for example, 3 minutes.

In this case, the “mute” flag is “0”, and the counting value of the timer is not more than 3 minutes. Therefore, it is judged that the state in which no person exists in front of the signage device 10 is not maintained for a predetermined time (No in Step S113), and the CPU 32 returns to the processing from Step S102 in order to maintain the state.

Thus, the processing is continued while the content output control is performed according to the customer's operation of the operation buttons B1 to B4 and the detection output of the human detection sensor PE.

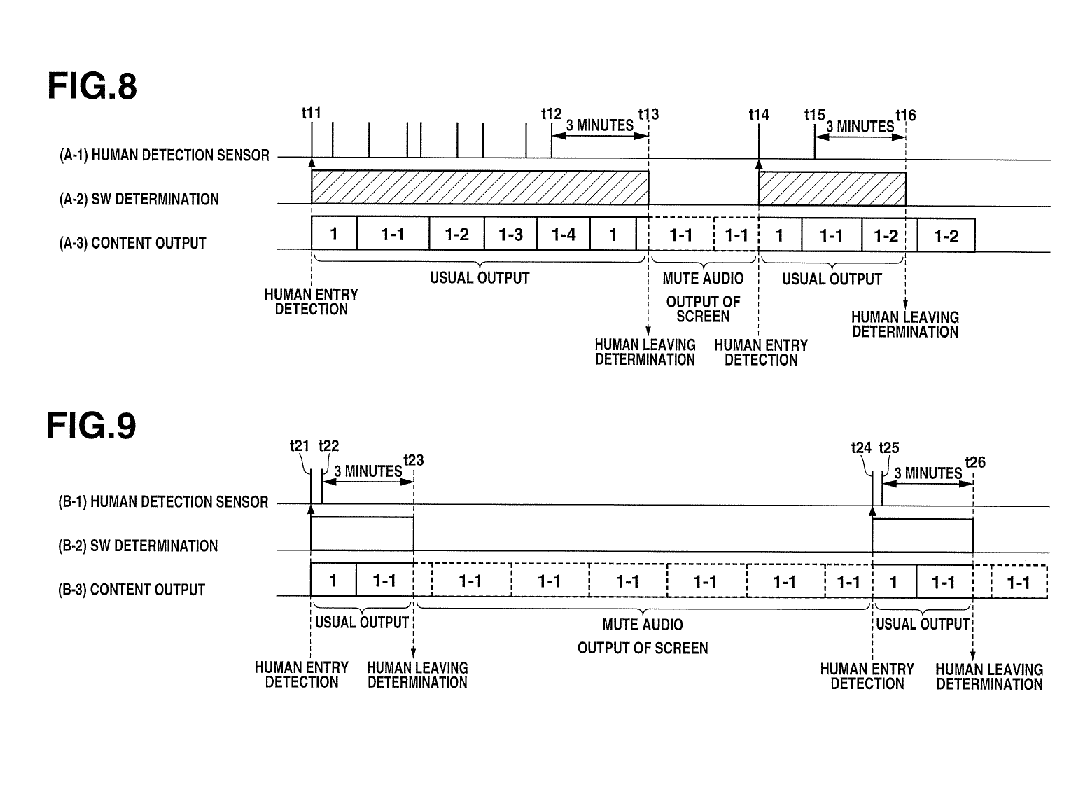

FIGS. 8 and 9 are views exemplifying a relationship among output of the human detection sensor PE, software (SW) determination output according to the operation program of the CPU 32, and content output.

In FIG. 8, as shown in (A-1), the output of the human detection sensor PE is appropriately detected during a period from timing t11 to timing t12. As shown in (A-2), the CPU 32 judges that a customer exists in front of the signage device 10 during a period from the timing t12 to timing t13 after a lapse of 3 minutes without the output of the human detection sensor PE. As shown in (A-3), usual content output using a moving image and audio is performed.

It is judged whether the state in which a customer does not exist has been maintained for a predetermined time at the timing t13. For example, during a period from when it has been judged that this state has been maintained for 3 minutes to timing t14 when the detection output of the human detection sensor PE is obtained again, the CPU 32 sets the mute flag to “1” to stop audio content and, thus, to perform content output using only a moving image, as shown in (A-3).

After that, the CPU 32 newly executes usual content output from the starting content “1” at the timing t14 when the detection output of the human detection sensor PE is obtained.

If a customer continuously does not exist after the detection output of the human detection sensor PE is obtained at timing t15, the usual content output state is maintained for a predetermined time, for example, until reaching timing t16 after a lapse of 3 minutes, for example. After that, the CPU 32 sets the mute flag to “1” again to stop the audio content and, thus, to perform content output using only a moving image, as shown in (A-3).

In FIG. 9, the output of the human detection sensor PE is detected at timing t21 and timing t22 as shown in (B-1). At this time, as shown in (B-2), the CPU 32 judges that a customer exists in front of the signage device 10 during a period from the timing t22 to timing t23 after a lapse of 3 minutes without the output of the human detection sensor PE, and, as shown in (B-3), usual content output using a moving image and audio is performed.

It is judged whether the state in which a customer does not exist has been maintained for a predetermined time at the timing t23. For example, during a period from when it has been judged that this state has been maintained for 3 minutes to timing t24 when the detection output of the human detection sensor PE is obtained again, the CPU 32 sets the mute flag to “1” to stop audio content and, thus, to perform content output using only a moving image, as shown in (B-3).

After that, the CPU 32 newly executes usual content output from the starting content “1” at the timing t24 when the detection output of the human detection sensor PE is obtained.

If a customer continuously does not exist after the detection output of the human detection sensor PE is obtained at timing t25, the usual content output state is maintained for a predetermined time, for example, until reaching timing t26 after a lapse of 3 minutes, for example. After that, the CPU 32 sets the mute flag to “1” again to stop the audio content and, thus, to perform content output using only a moving image, as shown in (B-3).

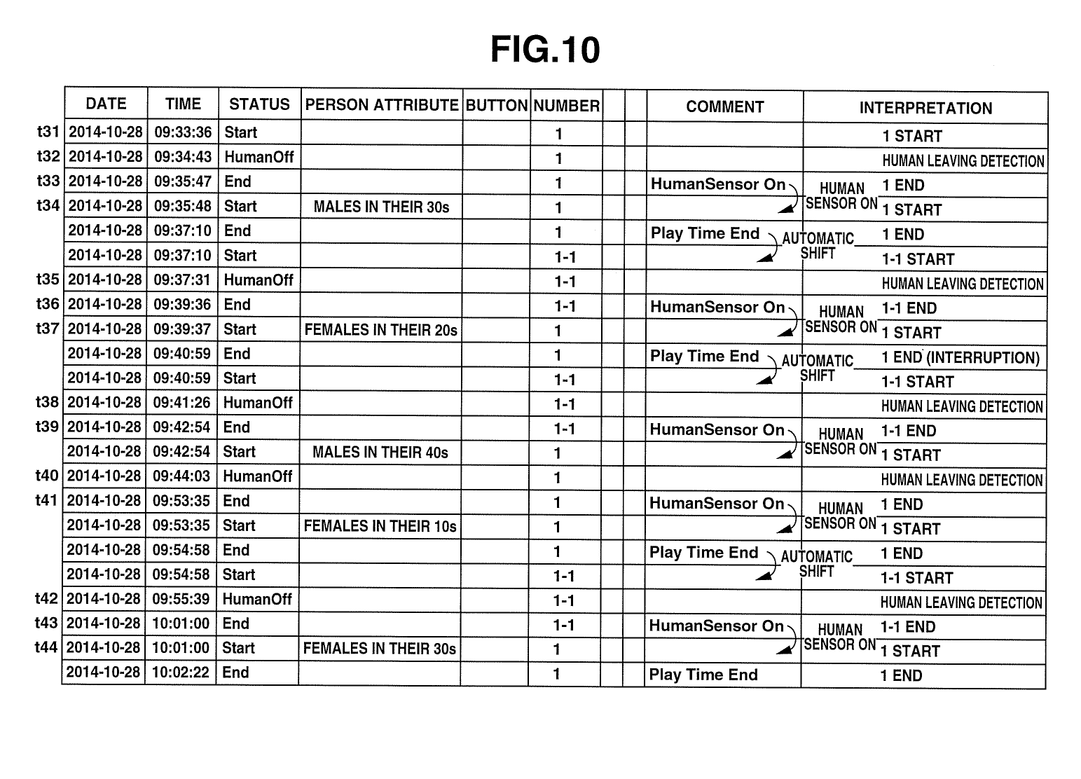

FIG. 10 shows a data sample of a content output log stored in the log storage part 20A of the content memory 20, as described above. In this data, the log is formed with items, “date”, “time”, “Status (detection state)”, “Person attribute”, “(content) Number”, and “Comment” as one set. In addition, in FIG. 10, items for explanation, “Comment” and “Interpretation” are provided as an aid to understanding.

In the example of FIG. 10, since content is viewed with good balance in terms of both age and sex, the CPU 32 evaluates that the content is content that can be intended for everyone. If it is judged that the number of information items stored in the “Person attribute”, for example, the number of males in their 30s is large as compared with other attributes, the CPU 32 may evaluate that content is suitable for males in their 30s. Thus, content is evaluated based on the “attribute information” stored in the log storage part 20A.

FIG. 10 shows a data sample in which a predetermined time for judging that a customer does not exist after the detection output of the human detection sensor PE is stopped is not set to 3 minutes as described in FIGS. 6 to 9 but is set to a significantly shorter time, for example, approximately 10 seconds.

For example, the presence of a customer is detected at timing t31 (2014-10-28/09:33:36), and once usual content output is started, the usual content output is continued for 1 minute, 7 seconds until it is judged that the customer has left at timing t32 (2014-10-28/09:34:43). However, after that, for 1 minute, 4 seconds until the presence of a customer is detected again at timing t33 (2014-10-28/09:35:47), audio content is stopped to output only moving image content.

Accordingly, a content output time is 2 minutes, 11 second at the timings t31 to t33, and when it is considered that a customer exists in this time, a output time of usual content using both a moving image and audio is 1 minute, 7 seconds.

Hereinafter, usual content output and output of only moving image content in which audio content is stopped are repeatedly executed in a similar pattern.

Consequently, in the CPU 32, in the entire time zone of the data sample of the output log shown in FIG. 10, a total output time of content is 28 minutes, 44 seconds. In terms of the output time of usual content using both a moving image and audio for when a customer exists within this time, it is 9 minutes, 14 seconds. This corresponds to an effective viewing time of content viewed when a customer existed of 32.1%, and the content is evaluated that 32.1% was effective. When content is thus evaluated by the ratio of the effective viewing time of content, relative evaluation can be performed even for content with a different output time.

The log data stored in the log storage part 20A of the content memory 20 is thus uploaded from each of the signage devices 10 to the content distribution server SV for, for example, each predetermined time, for example, for each “1 hour”. When counting processing required for each of the signage devices 10 is executed in the content distribution server SV, information for each store where each of the signage devices 10 is installed can be obtained.

As described above in detail, according to the present embodiment, information as a judgement material for ambient reaction to output of content can be obtained.

In the above embodiment, content which has been outputted up to a certain time is stopped once it is judged that a customer exists, based on the detection output of the human detection sensor PE from the state in which the customer has not existed until then. After that, output is newly started after returning to content positioned at the head, and therefore, content such as advertisements can be more effectively provided by devising the order of content data items.

Further, in the above embodiment, a plurality of pieces of content introducing individual commodities and the like are provided, an operation unit that selects the content is provided, and the selected content is outputted immediately after operation is received. Therefore, commodities and the like in which a customer is interested can be actively promoted.

Further, in the above embodiment, features of appearance of a customer, for example, the attribute information such as an age group and sex, using the face recognition processing and the like, are obtained, and since the obtained attribute information is stored as log data, more information effective for subsequent analysis can be stored together.

In the above embodiment, an actual counting operation is performed on the content distribution server SV side by the system using the signage devices 10 and the content distribution server SV. However, an apparatus which performs recording of data and counting processing with only the signage device 10 and which can output results obtained therefrom to the outside if necessary could also be considered.

Furthermore, in the above embodiment, a projector using a projector technology of the DLP™ (Digital Light Processing) type has been described as each of the signage devices 10. However, this invention does not limit a means of outputting a video to a projector, and is similarly applicable to a device using a flat display panel such as a color liquid crystal panel with backlight.

Moreover, the present invention is not limited to the embodiments described previously, and can be variously modified in the implementation stage within the scope not deviating from the gist of the invention. Further, the functions to be carried out in the above-mentioned embodiments may be appropriately combined within the limits of the possibility of implementation. Various stages are included in the embodiments described above, and by appropriately combining a plurality of constituent elements, various inventions can be extracted. For example, even when some constituent elements are deleted from all the constituent elements shown in the embodiments, if an advantage can be obtained, the configuration from which the constituent elements are deleted can be extracted as an invention.

What is claimed is:

1. A content output apparatus comprising:
an output unit which starts outputting content based on entry of a person into a predetermined area;
a detection unit which detects a person viewing the content outputted by the output unit; and
an evaluation unit which evaluates the content based on a ratio of a content output time outputted by the output unit and a detect time representing a person detected by the detection unit.

2. The content output apparatus according to claim 1, further comprising a recording unit which relates and records the content output time and the detect time,
wherein the evaluation unit evaluates the content based on the recorded the content output time and the recorded the detect time.

3. The content output apparatus according to claim 1, further comprising a first output control unit which controls the output unit to output content in order from the head of the content once the person is detected by the detection unit.

4. The content output apparatus according to claim 2, further comprising a first output control unit which controls the output unit to output content in order from the head of the content once the person is detected by the detection unit.

5. The content output apparatus according to claim 1,
wherein
the output unit continuously outputs a plurality of pieces of content,
further comprising an operation unit configured to select one of the plurality of pieces of content; and
a second output control unit which controls the output unit to output the selected content based on operation results in the operation unit,
wherein the evaluation unit evaluates the content based on the output time for each of the plurality of pieces of content and the operation results in the operation unit.

6. The content output apparatus according to claim 2, wherein the output unit continuously outputs a plurality of pieces of content,
further comprising an operation unit configured to select one of the plurality of pieces of content; and
a second output control unit which controls the output unit to output the selected content based on operation results in the operation unit,
wherein the evaluation unit evaluates the content based on the output time for each of the plurality of pieces of content and the operation results in the operation unit.

7. The content output apparatus according to claim 1, further comprising an attribute acquisition unit which obtains attribute information from an appearance of the person when the person is detected by the detection unit,
wherein the evaluation unit evaluates content with the attribute information obtained by the attribute acquisition unit.

8. The content output apparatus according to claim 2, further comprising an attribute acquisition unit which obtains attribute information from an appearance of the person when the presence of the person is detected by the detection unit,
wherein the evaluation unit evaluates content with the attribute information obtained by the attribute acquisition unit.

9. The content output apparatus according to claim 3, further comprising an attribute acquisition unit which obtains attribute information from an appearance of the person when the presence of the person is detected by the detection unit,
wherein the evaluation unit evaluates content with the attribute information obtained by the attribute acquisition unit.

10. The content output apparatus according to claim 4, further comprising an attribute acquisition unit which obtains attribute information from an appearance of the person when the presence of the person is detected by the detection unit,
wherein the evaluation unit evaluates content with the attribute information obtained by the attribute acquisition unit.

11. The content output apparatus according to claim 5, further comprising an attribute acquisition unit which obtains attribute information from an appearance of the person when the presence of the person is detected by the detection unit,
wherein the evaluation unit evaluates content with the attribute information obtained by the attribute acquisition unit.

12. The content output apparatus according to claim 6, further comprising an attribute acquisition unit which obtains attribute information from an appearance of the person when the presence of the person is detected by the detection unit,
wherein the evaluation unit evaluates content with the attribute information obtained by the attribute acquisition unit.

13. A content output system comprising an output apparatus comprising a output unit which starts outputting content based on entry of a person into a predetermined area and a server device which controls the overall operation of the output apparatus, comprising:
a detection unit which detects a person viewing the content outputted by the output unit; and
an evaluation unit which evaluates the content based on a ratio of a content output time outputted by the output unit and a detect time representing a person detected by the detection unit.

14. A content output method performed by an apparatus comprising a output unit which starts outputting content based on entry of a person into a predetermined area, comprising:
detecting a person viewing the content outputted by the output unit; and
evaluating the content based on a ratio of a content output time outputted by the output unit and a detect time representing a person detected in the detecting.

15. A computer readable non-transitory storage medium which stores a program including a series of commands allowing a computer with a built-in device comprising a output unit which starts outputting content based on entry of a person into a predetermined area to have the following functions of
a detection function which detects a person viewing the content outputted by the output unit and
an evaluation function which evaluates the content based on a ratio of a content output time outputted by the output unit and a detect time representing a person detected by the detection function.
